(19) United States
(12) Patent Application Publication
(10) Pub. No.: US 2023/0115992 A1
(43) Pub. Date: Apr. 13, 2023

(54) OIL AND FAT FOR CHOCOLATE PRODUCTS WHICH IS SUITABLE FOR COMPLEX CONFECTION

(71) Applicant: FUJI OIL HOLDINGS INC., Osaka (JP)

(72) Inventor: Akira MORITA, Osaka (JP)

(73) Assignee: FUJI OIL HOLDINGS INC., Osaka (JP)

(21) Appl. No.: 17/907,965

(22) PCT Filed: Jan. 28, 2021
(86) PCT No.: PCT/JP2021/003006

§ 371 Date: Aug. 29, 2022

(30) Foreign Application Priority Data
Mar. 11, 2020 (JP) 2020-041654

(51) Int. Cl. A23D 9/00; A23G 1/38

(52) U.S. Cl. CPC A23D 9/00; A23G 1/38

(57) ABSTRACT

The problem of providing an oil and fat for chocolate products and a chocolate product each having oil and fat migration/blooming resistance and post-tempering thickening resistance can be solved by an oil and fat for chocolate products according to the present invention, an oil or fat for chocolate products according to the present invention which is obtained by mixing an oil and fat mainly composed of a StOSt triglyceride with a low-melting-point fraction of palm oil that serving as a liquid oil component and further contains a specific amount of an OStO component.

### TECHNICAL FIELD

The present invention relates to an oil and fat for chocolate products and particularly to an oil and fat for chocolate products which is used in a complex confection.

### BACKGROUND ART

Chocolate and complex confections obtained by combining chocolate with baked confections such as biscuits or pretzels have been popular products. In general, chocolate parts of complex confections are made from oils and fats which are hard at normal temperature, but baked confections contain a large amount of liquid oil, such as kneaded margarine or a spray oil and fat, which is relatively soft at normal temperature. Therefore, there are problems that liquid oil components may move from a part with a high content to a part with a low content due to the difference in the content of liquid oil components in both parts, blooming may occur on the surface of chocolate, and the chocolate part may soften. In addition, complex confections obtained by combining chocolate with seeds also have the same problems. Accordingly, there is a great demand from the market for technology for solving these problems associated with oil and fat migration.

In order to solve the above-described problems. Literature 1 proposes an oil and fat composition containing 1,3-palmito-2-olein (hereinafter, abbreviated as POP), 1-palmito-2-oleo-3-stearin (hereinafter, abbreviated as POSt), 1,3-stearo-2-olein (hereinafter, abbreviated as StOSt), and a liquid oil at specific amounts. In addition. Literature 2 proposes an oil and fat for chocolate obtained by combining a liquid oil with an oil and fat which is mainly composed of a StOSt triglyceride and has few minor components such as StLSt or StStO triglycerides.

On the other hand, among complex confections, baked confections such as biscuits or crackers or confectionery materials such as nuts such as peanuts are sometimes subjected to chocolate-coating (enrobing work), for example. In this case, in addition to good tempering workability required for oils and fats for chocolate in the related art, there is often a need for maintaining a low viscosity of chocolate dough for a long period of time after tempering. These characteristics not only eliminate the need for complicated adjustment of the temperature of chocolate dough during enrobing work but also enable a desired control of the weight per unit area of chocolate with respect to confectionery materials.

### CITATION LIST

### Patent Literature

Patent Literature 1: PCT International Publication No. WO2011/115063

Patent Literature 2: PCT International Publication No. WO2013/065726

### SUMMARY OF INVENTION

### Technical Problem

An objective of the present invention is to provide an oil and fat for chocolate products which has oil and fat migration/blooming resistance and post-tempering thickening resistance.

### Solution to Problem

The present inventors have been studying an oil and fat for chocolate products having excellent enrobing aptitude and bloom resistance and have found that there is a problem that heat resistance of chocolate inevitably deteriorates in a situation where a large amount of liquid oil is mixed with the oil and fat composition containing POP. POSt, StOSt, and the liquid oil at specific amounts as in Literature 1. In addition, it has been found that the oil and fat for chocolate, which is obtained by combining a liquid oil with an oil and fat mainly composed of a StOSt triglyceride as in Literature 2 and in which the problem such as heat resistance as described above is unlikely to occur due to a relatively high melting point of a StOSt triglyceride, is excellent as a usual oil and fat for chocolate to be combined with baked confections. However, it has been found that, in chocolate dough for enrobing which is particularly required to maintain a low viscosity for a long period of time after tempering, the viscosity of the chocolate dough sometimes exceeds the allowable limit.

The present inventors have conducted extensive studies, and as a result, they have found that the above-described problems can be solved by mixing an oil and fat mainly composed of a StOSt triglyceride with a low-melting-point fraction of palm oil as a liquid oil and further incorporating a specific amount of an OStO component, thus leading to realization of the present invention.

That is, the present invention relates to the following.

(1) An oil and fat for chocolate products which is obtained by mixing an oil and fat containing a StOSt triglyceride with a low-melting-point fraction of palm oil and an oil and fat containing an OStO triglyceride and satisfies (a) to (c) below,

(a) a content of the StOSt triglyceride in the oil and fat for chocolate products is 25 to 45 weight %,

(b) an OStO-to-StO2 ratio in the oil and fat for chocolate products is greater than or equal to 0.08, and

(c) a content of a liquid oil component in the oil and fat for chocolate products is 15 to 55 weight %,

where St represents stearic acid and O represents oleic acid; StOSt represents a triglyceride in which fatty acids at positions 1 and 3 are St and a fatty acid at position 2 is O, OStO represents a triglyceride in which fatty acids at positions 1 and 3 are O and a fatty acid at position 2 is St, and StO2 represents a triglyceride containing one St and two O's; and the liquid oil component represents a triglyceride having two or more unsaturated fatty acids having 16 or more carbon atoms in one molecule.

(2) The oil and fat for chocolate products according to (1), in which a content of a diglyceride in the oil and fat for chocolate products is 3 to 10 weight %, a content of PO2 is 8 to 22 weight %, and a content of StO2 is 2 to 10 weight %, where PO2 represents a triglyceride having one P and two O's.

(3) The oil and fat for chocolate products according to (1) or (2), in which there is 0.3 to 2.5 weight % of an S3 triglyceride in the oil and fat for chocolate products, where S3 represents a triglyceride having three saturated fatty acids having 16 or more carbon atoms.

(4) Chocolate products in which the oil and fat for chocolate products according to any one of (1) to (3) is used.

(5) A complex confection obtained by combining the chocolate products according to (4) with an oil and fat food material.

### Advantageous Effects of Invention

According to the present invention, the decrease in heat resistance which tends to occur in an oil and fat for chocolate products into which a liquid oil is incorporated is suppressed.

### DESCRIPTION OF EMBODIMENTS

(StOSt-Containing Oil and Fat)

It is necessary to incorporate an oil and fat containing a StOSt triglyceride into the oil and fat for chocolate products of the present invention. The content of StOSt in the oil and fat is preferably 40 weight % or more, more preferably 50 weight % or more, still more preferably 55 weight % or more, most preferably 60 weight % or more, and still most preferably 65 weight % or more. In addition, the content thereof is preferably 80 weight % or less and more preferably 75 weight % or less.

(StOSt-Containing Oil and Fat)

A method for producing the StOSt-containing oil and fat is not particularly limited, but the StOSt-containing oil and fat can be obtained by fractionating vegetable oils and fats such as cocoa butter, shea fat, sal fat, and illipe fat, vegetable oils containing a high content of oleic acid, and oils and fats obtained through transesterification specifically at positions 1 and 3 of stearic acid, as necessary.

(Content of StOSt)

The oil and fat for chocolate products of the present invention needs to have a content of a StOSt triglyceride of 25 to 45 weight %, preferably 27 weight % or more, more preferably 29 weight % or more, and still more preferably 31 weight % or more. In addition, the content thereof is preferably 43 weight % or less, more preferably 41 weight % or less, still more preferably 39 weight % or less, and most preferably 37 weight % or less. If the content of a StOSt triglyceride is less than the lower limit value, softening of chocolate products may occur and heat-resistant shape retention properties may be inferior. In addition, if the content thereof exceeds the upper limit, thickening may occur beyond the allowable range after tempering chocolate products, oil and fat migration resistance may decrease, and bloom may easily occur.

(Content of SOS)

The content of a SOS triglyceride in the oil and fat for chocolate products of the present invention is preferably 35 weight % or more, more preferably 39 weight % or more, and still more preferably 43 weight % or more. When the oil and fat for chocolate products including less than 35 weight % of a SOS triglyceride is used as a substitute fat for cacao butter, softening of chocolate products may occur and compatibility with cacao fat may deteriorate. Here, S represents a C16 or higher saturated fatty acid.

(OStO-Containing Oil and Fat)

An oil and fat containing an OStO triglyceride needs to be incorporated into oil and fat the oil and fat for chocolate products of the present invention, and the content of OStO in the oil and fat is preferably 5 weight % or more, more preferably 7 weight % or more, and still more preferably 10 weight % or more.

(OStO-to-StO2 Ratio)

The oil and fat for chocolate products of the present invention needs to have an OStO-to-StO2 ratio of 0.08 or more, preferably 0.10 or more, more preferably 0.12 or more, and most preferably 0.14 or more. If the OStO-to-StO2 ratio is less than the lower limit value, thickening may occur beyond the allowable range after tempering chocolate products.

Although it is not yet clear by what mechanism the thickening is suppressed by incorporating an OStO triglyceride into the oil and fat for chocolate products of the present invention, it is thought that one of the reasons for this is that the change in the crystalline state of the oil and fat for chocolate products of the present invention over time can be suppressed by intermolecular compound crystals formed by OStO and equimolar StOSt.

(Low-Melting-Point Fraction of Palm Oil)

It is necessary to incorporate a low-melting-point fraction of palm oil into the oil and fat for chocolate products of the present invention. The iodine value of a low-melting-point fraction of palm oil is preferably 53 or more, more preferably 55 or more, still more preferably 60 or more, and most preferably 65 or more. In addition, the iodine value thereof is preferably 90 or less and more preferably 80 or less.

(Content of Liquid Oil Component)

The oil and fat for chocolate products of the present invention needs to have a content of a liquid oil component of 15 to 55 weight %, preferably 25 weight % or more, and more preferably 30 weight % or more. In addition, the content thereof is preferably 50 weight % or less and more preferably 45 weight % or less. If the content of a liquid oil component is less than the lower limit value, the oil and fat migration resistance may decrease and bloom may be likely to occur. In addition, if the content thereof exceeds the upper limit value, the heat resistance of chocolate products may decrease and the bite may become too soft. Here, the liquid oil component represents a triglyceride having two or more unsaturated fatty acids having 16 or more carbon atoms in one molecule.

(Content of Diglyceride)

The content of a diglyceride in the oil and fat for chocolate products of the present invention is preferably 3 to 10 weight %, more preferably 3.5 weight % or more, still more preferably 4 weight % or more, most preferably 4.5 weight % or more, and still most preferably 4.7 weight % or more. In addition, the content thereof is preferably 9 weight % or less, more preferably 8.5 weight % or less, still more preferably 8 weight % or less, most preferably 7.5 weight % or less, and still most preferably 7 weight % or less. If the content of a diglyceride is less than the lower limit value, thickening may occur beyond the allowable range after tempering chocolate products, which is not preferable.

(Content of PO2)

The content of PO2 in the oil and fat for chocolate products of the present invention is preferably 8 to 22 weight %, more preferably 10 weight % or more, still more preferably 12 weight % or more, and most preferably 14 weight % or more. In addition, the content thereof is more preferably 20 weight % or less, still more preferably 19 weight % or less, and most preferably 18 weight % or less.

(Content of StO2 and Content of S3)

The content of StO2 in the oil and fat for chocolate products of the present invention is preferably 2 to 10 weight %, more preferably 3 weight % or more, still more preferably 4 weight % or more, most preferably 4.5 weight % or more, and still most preferably 5 weight % or more.

In addition, the content thereof is more preferably 9 weight % or less, still more preferably 8 weight % or less, and most preferably 7 weight % or less.

The content of S3 in the oil and fat for chocolate products of the present invention is preferably 0.3 to 2.5 weight %, more preferably 0.6 weight % or more, still more preferably 0.8 weight % or more, and most preferably 0.9 weight % or more. In addition, the content thereof is more preferably 2 weight % or less, still more preferably 1.8 weight % or less, and most preferably 1.5 weight % or less.

(Formulation Ratio Between Oils and Fats)

The oil and fat for chocolate products of the present invention is obtained by mixing an oil and fat containing a StOSt triglyceride with a low-melting-point fraction of palm oil and an oil and fat containing an OStO triglyceride. The formulation amount of the oil and fat containing a StOSt triglyceride is preferably 30 to 65 weight %, more preferably 35 to 60 weight %, and still more preferably 40 to 55 weight %. The formulation amount of the oil and fat containing an OStO triglyceride is preferably 3 to 20 weight %, more preferably 4 to 15 weight %, and still more preferably 5 to 12 weight %. The formulation amount of a low-melting-point fraction of palm oil is preferably 32 to 67 weight %, more preferably 36 to 60 weight %, and still more preferably 40 to 52 weight %.

(Amount Used for Chocolate Products)

The amount of the oil and fat for chocolate products used for chocolate products to exhibit a desired effect of the present invention is preferably 3 weight % or more, more preferably 5 weight % or more, still more preferably 8 weight % or more, and most preferably 10 weight % or more. The chocolate products described in the present invention are not limited to chocolate products in the “Fair Competition Code for Labeling Chocolate Products” established by the National Fair Trade Commission for chocolate industry and include oil and fat processed foods obtained by processing saccharides or powdered milk and an edible oil and fat as main raw materials regardless of the use of cacao raw materials.

(Additives)

Arbitrary components such as colorants, emulsifiers, antioxidants, and flavoring agents used in ordinary confectionery applications can be appropriately added to the chocolate products or the oil and fat for chocolate products of the present invention. The amounts of these components added are 10 weight % or less and preferably 5 weight % or less based on the oil and fat for chocolate products of the present invention.

Examples of the emulsifiers include glycerin fatty acid esters, sucrose fatty acid esters, sorbitan fatty acid esters, glycerol organic fatty acid esters, polyglycerin fatty acid esters, and lecithin.

(Complex Confection)

A complex confection of the present invention is obtained by combining the chocolate products with an oil and fat food material. Examples of oil and fat food materials include baked confections, snacks, fried confections, cakes, cream products, candies, fillings, and nut pastes, but the present invention is not limited thereto as long as the food materials contain liquid oil.

### EXAMPLES

Examples will be described below, but technical ideas of this invention are not limited to these examples. The units “parts” and “%” in the examples are all on a weight basis.

(Measurement Method)

The content of each triglyceride in an oil and fat for chocolate products can be measured and obtained as the sum of contrast-type and asymmetric triglycerides (for example, the sum of the content of OStO and the content of StOO, that is, the content of StO2) through high performance liquid chromatographic analysis (1) shown below. Furthermore, the asymmetric triglyceride composition can be measured through high performance liquid chromatographic analysis (2) and obtained as (OStO/StO2), and can be multiplied by the result of (1) to obtain each of the contents of OStO and StOO.

The high performance liquid chromatographic analysis (1) was carried out (column: ODS, eluent: acetone/acetonitrile=80/20, liquid volume: 0.9 mL/minute, column temperature: 25° C., and detector: differential refractometer).

The high performance liquid chromatographic analysis (2) was carried out according to the description in J. HighResol. Chromatogr., 18, 105-107 (1995) ADLOF RO, “Analysis of Triacylglycerol Positional Isomers by Silver Ion High Performance Liquid Chromatography.”

(Preparation of StOSt-Containing Fat (Oil and Fat A))

After mixing high oleic sunflower oil with ethyl stearate, and transesterification was performed using lipase having selectivity for positions 1 and 3 to obtain reaction oil. Ethyl esters were distilled off from this reaction oil through distillation, solvent fractionation was further performed using acetone, and the oil and fat composition having an increased StOSt triglyceride concentration was purified according to a usual method to obtain an oil and fat A-1 having a content of StOSt of 75.6% and an oil and fat A-2 having a content of StOSt of 68.0%.

(Preparation of OStO-Containing Fat (Oil and Fat B))

High oleic sunflower oil and extremely hardened oil of rapeseed oil were mixed with each other and adjusted to have a stearic acid (St)-to-oleic acid (O) ratio of 2, and were then subjected to random transesterification using sodium methylate as a catalyst. Furthermore, solvent fractionation in which acetone was used was performed using the transesterified oil, and the oil and fat composition having an increased OStO triglyceride concentration was purified according to the usual way to obtain an oil and fat B having a content of OStO of 12.9% and a content of StOO of 25.7%. Here, OStO represents a triglyceride in which fatty acids at positions 1 and 3 are O and a fatty acid at position 2 is St, and StOO represents a triglyceride in which a fatty acid at position 1 or 3 is St and fatty acids at other positions are O.

The oil and fat A-1, the oil and fat A-2 the oil and fat B, a low-melting-point fraction of palm oil (an iodine value of 67.0, a content of a liquid oil component of 67.5 mass % manufactured by FUJI OIL CO., LTD.), and a medium-melting-point fraction of palm oil (a content of POP of 66.2 mass %, manufactured by FUJI OIL CO., LTD.) were mixed with each other at proportions shown in Table 1 and oils or fats for chocolate products of Examples 1 and 2 and Comparative Examples 1 and 2 were obtained. The compositions of the triglycerides are shown in Table 2.

TABLE 1
Oil and fat composition (weight %)

| | Example | Example | Comparative | Comparative |
|---|---|---|---|---|
| | 1 | 2 | Example 1 | Example 2 |
| Medium-melting-point | 0.4 | 0.5 | | 51.4 |
| fraction of palm oil | | | | |
| Low-melting-point | 48.8 | 44.8 | 55.0 | |
| fraction of palm oil | | | | |
| Oil and fat A-1 | 44.8 | 44.7 | 45.0 | |
| Oil and fat A-2 | | | | 48.6 |
| Oil and fat B | 6.0 | 10.0 | | |

TABLE 2
Triglyceride composition (weight %)

| | | | Comparative | Comparative |
|---|---|---|---|---|
| | Example 1 | Example 2 | Example 1 | Example 2 |
| Diglyceride | 5.3 | 5.8 | 4.6 | 2.2 |
| PO2 | 16.2 | 15.2 | 17.8 | 2.2 |
| StO2 | 5.2 | 6.6 | 3.2 | 4.5 |
| Liquid oil | 38.4 | 38.3 | 38.6 | 9.5 |
| component | | | | |
| POP | 6.4 | 6.1 | 6.7 | 33.9 |
| POSt | 4.7 | 4.7 | 4.5 | 11.8 |
| StOSt | 34.2 | 34.3 | 34.1 | 32.6 |
| SOS | 47.3 | 47.2 | 47.4 | 81.8 |
| S3 | 1.0 | 1.0 | 1.0 | 1.5 |
| OStO | 0.8 | 1.3 | 0.0 | 0.1 |
| OStO-to-StO2 | 0.15 | 0.20 | 0.00 | 0.02 |
| ratio | | | | |

(Production of Chocolate Products)

10.0 Parts of each of oils or fats for chocolate products of Examples 1 and 2 and Comparative Examples 1 and 2, 7.6 parts of cocoa butter, 31.5 parts of cacao mass, 6.7 parts of whole milk powder, 44.2 parts of powdered sugar, and 0.5 parts of lecithin were mixed with each other to produce chocolate dough (oil and fat content of 37.2 weight %) through a usual method, and the state of increase in viscosity after tempering and the state of occurrence of bloom and migration of an oil and fat were observed.

(Evaluation of Oil and Fat Migration/Blooming Resistance)

After subjecting each chocolate dough piece to a tempering treatment, commercially available pretzels were enrobed in a state in which the temperature was maintained at 30° C., and the surface condition of the chocolate was observed for 85 days while the enrobed pretzels were allowed to stand at 20° C. The results are shown in Table 3.

TABLE 3
Oil and fat migration/blooming resistance

| Test oil and | Number of days elapsed | | | | | | | | | | |
|---|---|---|---|---|---|---|---|---|---|---|---|
| fat | 14 | 22 | 26 | 29 | 34 | 39 | 48 | 56 | 61 | 78 | 85 |
| Example 1 | − | ± | ± | ± | ± | ± | ± | ±/+ | ±/+ | ±/+ | + |
| Example 2 | − | ± | ± | ± | ± | ± | ± | ± | ± | ±/+ | + |
| Comparative | − | − | − | − | ± | ± | ± | ± | ± | ± | ± |
| Example 1 | | | | | | | | | | | |
| Comparative | 3+ | 3+ | 3+ | 3+ | 3+ | 3+ | 3+ | 3+ | 3+ | 3+ | 3+ |
| Example 2 | | | | | | | | | | | |

(Evaluation Criteria)
−: Glossy,
±: Cloudy,
±/+: Midway between ± and +,
+: Bloom,
2+: Slightly violent bloom,
3+: violent bloom

Those with 70 days or more of being + (bloom) were regarded as acceptable.

(Evaluation of Increase in Viscosity after Tempering)

After subjecting 1 kg of each chocolate dough piece to a tempering treatment, a sample was collected every 20 minutes while stirring was continued in a state in which the temperature was maintained at 31° C., and the viscosity was measured (BH-type viscometer, rotor No. 5, 10 rpm). The results are shown in Table 4.

TABLE 4
Increase in viscosity after tempering

| | | | | | Difference in |
|---|---|---|---|---|---|
| | Viscosity (P) | | | | viscosity between |
| Test oil | 0 | 20 | 40 | 60 | at 0 minutes and |
| and fat | minutes | minutes | minutes | minutes | after 60 minutes |
| Example 1 | 90 | 94 | 110 | 126 | 36 |
| Example 2 | 86 | 90 | 110 | 133 | 47 |
| Comparative | 85 | 93 | 119 | 159 | 74 |
| Example 1 | | | | | |
| Comparative | 83 | 89 | 106 | 130 | 47 |
| Example 2 | | | | | |

Those having a difference of 55P between the initial viscosity at the start (0 minutes) of stirring and the viscosity after 60 minutes were regarded as acceptable.

(Evaluation Summary) The chocolate products of Example 1 and Example 2 passed both the evaluation of the oil and fat migration/blooming resistance and the evaluation of the thickening resistance. The chocolate of Comparative Example 1 failed the evaluation of the increase in the viscosity after tempering. The chocolate of Comparative Example 2 failed the evaluation of the oil and fat migration/blooming resistance.

### INDUSTRIAL APPLICABILITY

Since chocolate products having excellent enrobing aptitude and bloom resistance can be obtained, higher-quality complex confections can be provided to the market.

1. An oil and fat for chocolate products comprising:
an oil and fat containing a StOSt triglyceride;
a low-melting-point fraction of palm oil; and
an oil and fat containing an OStO triglyceride,
wherein the oil and fat for chocolate products satisfies (a) to (c) below,
(a) a content of the StOSt triglyceride in the oil and fat for chocolate products is 25 to 45 weight %,
(b) an OStO-to-StO2 ratio in the oil and fat for chocolate products is greater than or equal to 0.08, and
(c) a content of a liquid oil component in the oil and fat for chocolate products is 15 to 55 weight %,
where St represents stearic acid and O represents oleic acid; StOSt represents a triglyceride in which fatty acids at positions 1 and 3 are St and a fatty acid at position 2 is O, OStO represents a triglyceride in which fatty acids at positions 1 and 3 are O and a fatty acid at position 2 is St, and StO2 represents a triglyceride containing one St and two O's; and the liquid oil component represents a triglyceride having two or more unsaturated fatty acids having 16 or more carbon atoms in one molecule.

2. The oil and fat for chocolate products according to claim 1,
wherein a content of a diglyceride in the oil and fat for chocolate products is 3 to 10 weight %, a content of PO2 is 8 to 22 weight %, and a content of StO2 is 2 to 10 weight %,
where PO2 represents a triglyceride having one P and two O's.

3. The oil and fat for chocolate products according to claim 1,
wherein there is 0.3 to 2.5 weight % of an S3 triglyceride in the oil and fat for chocolate products,
where S3 represents a triglyceride having three saturated fatty acids having 16 or more carbon atoms.

4. Chocolate products in which the oil and fat for chocolate products according to claim 1 is used.

5. A complex confection obtained by combining the chocolate products according to claim 4 with an oil and fat food material.

6. The oil and fat for chocolate products according to claim 2,
wherein there is 0.3 to 2.5 weight % of an S3 triglyceride in the oil and fat for chocolate products,
where S3 represents a triglyceride having three saturated fatty acids having 16 or more carbon atoms.

7. Chocolate products in which the oil and fat for chocolate products according to claim 2 is used.

8. Chocolate products in which the oil and fat for chocolate products according to claim 3 is used.

9. Chocolate products in which the oil and fat for chocolate products according to claim 6 is used.

10. A complex confection obtained by combining the chocolate products according to claim 7 with an oil and fat food material.

11. A complex confection obtained by combining the chocolate products according to claim 8 with an oil and fat food material.

12. A complex confection obtained by combining the chocolate products according to claim 9 with an oil and fat food material.
